(19) United States
(12) Patent Application Publication
(10) Pub. No.: US 2022/0322618 A1
(43) Pub. Date: Oct. 13, 2022

(54) Attachment for Stump Grinder

(71) Applicant: Jerrold Burr, Denver, CO (US)

(72) Inventor: Jerrold Burr, Denver, CO (US)

(21) Appl. No.: 17/716,285

(22) Filed: Apr. 8, 2022

Related U.S. Application Data
(60) Provisional application No. 63/172,869, filed on Apr. 9, 2021.

(51) Int. Cl. A01G 23/06; B02C 18/18

(52) U.S. Cl. CPC A01G 23/067; B02C 18/18

(57) ABSTRACT

Embodiments in this disclosure include a cutting tool mounting block that is securely mounted to the periphery of a wheel. The mounting block includes a body portion with a channel having a width that expands along the length of the body portion. The cutting tool mounting block also includes an aperture configured to accept a single cutting tooth, in some embodiments. The cutting tool mounting block may also include a front feature that creates a clearance between the cutting tooth surface and the body portion. Some embodiments include the assembly of three mounting blocks on a stump grinder wheel, which can increases the bite each tooth takes, it can decrease the drag in the cutting wheel, and it can decrease chip recirculation.

### CROSS REFERENCE TO RELATED APPLICATIONS

This application claims the benefit of U.S. Provisional Patent Application No. 63/172,869, filed on Apr. 9, 2021, the contents of which are herein incorporated by reference in their entirety.

### TECHNICAL FIELD

Embodiments of the present disclosure are related to stump grinders. More specifically, the present disclosure relates to attachments to stump grinding cutter wheels.

### BACKGROUND

Tree stumps can cause safety concerns and can be a nuisance. For example, they can cause a tripping hazard, make lawn care more complicated, bring pests and weeds, and make a yard less attractive. There are two primary ways to remove these tree stumps: stump removal and stump grinding. Stump grinding has many benefits over stump removal, including that it is more cost effective and it is a less invasive procedure. Stump grinding can be performed with a range of different equipment, ranging in size and efficiency. The most common type of equipment used is rotary equipment. The rotary equipment is typically outfitted with cutting materials that chew away at the stump.

### BRIEF SUMMARY

Embodiments of the present disclosure include a cutting tool mounting block assembly that increases the efficiency of each cutting tooth and decreases the paddlewheel effect during stump grinding operations. Specifically, some embodiments relate to a cutting tool mounting block having a body portion and an aperture. The body portion defines a channel that is operable to mount over a stump grinding cutting wheel. The body portion can also include a fastening feature to secure the body portion to the wheel. The aperture can have a central axis that is configured to accept a cutting tooth. The central axis is substantially aligned with the channel in a radial direction, in some embodiments.

According to one embodiment, the cutting tool mounting block includes a front feature on the body portion. The front feature can be configured such that a radial distance between the center of the cutting wheel and the front feature is less than the radial distance between the center of the cutting wheel and the outermost edge of the body portion. According to some embodiments, when the cutting tooth is mounted, the length of the cutting tooth aligns to the direction of cutting; or tangent to the periphery of the wheel.

According to one embodiment, the fastening feature of the mounting blocks include two fasteners, the two fasteners secured through two bores on the body portion. In some embodiments, the body portion is counterbored on the first side of the body portion and threaded on the second side of the body portion to secure the fasteners.

Embodiments of the present disclosure also describe a stump grinding assembly configuration for stump removal, including three mounting blocks, three cutting teeth, and a cutting wheel. One embodiment can be used with stump grinding machines of 40 horsepower or less. In one embodiment, each mounting block and cutting tooth assembly is equidistantly spaced.

The drawings and detailed description are to be regarded as illustrative and not restrictive.

### BRIEF DESCRIPTION OF THE DRAWINGS

FIG. 1 illustrates an example of stump grinding assembly;

FIG. 2 illustrates an example of a side view of the cutting tool mounting block and cutting tooth as shown in FIG. 1;

FIG. 3 illustrates an example of an enlarged side view of the cutting tool mounting block and cutting tooth of FIGS. 1 and 2;

FIG. 4 illustrates an isometric view of the cutting tool mounting block and cutting tooth of FIGS. 1-3 secured to the wheel;

FIG. 5 illustrates an example of a front cross-sectional view of the cutting tool mounting block and the wheel shown in FIGS. 1-4;

FIG. 6 illustrates a plan view of the example cutting tool mounting block and cutting tooth shown in FIGS. 1-5;

FIG. 7 illustrates an isometric view of an example cutting tool mounting block;

FIG. 8 illustrates an isometric view of the example cutting tool mounting block of FIG. 7; and

FIG. 9 illustrates a top cross-sectional view of the example cutting tool mounting block of FIGS. 7-8.

### DETAILED DESCRIPTION

Embodiments of the present disclosure include a stump grinding mounting block that can be coupled with a stump grinder cutter wheel.

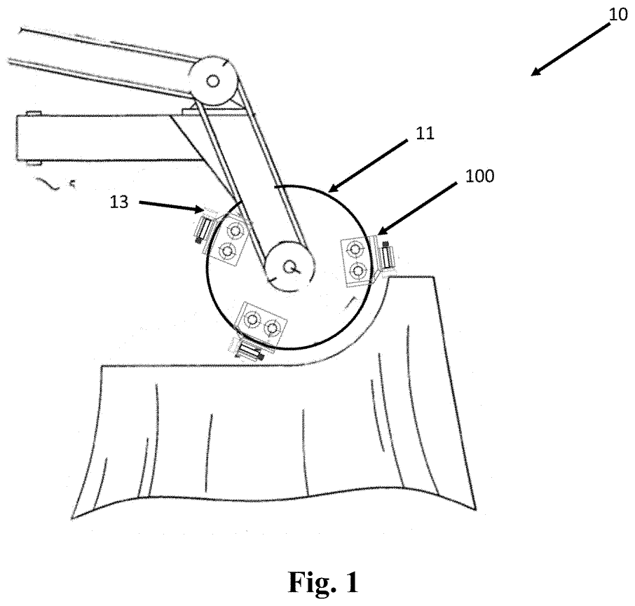

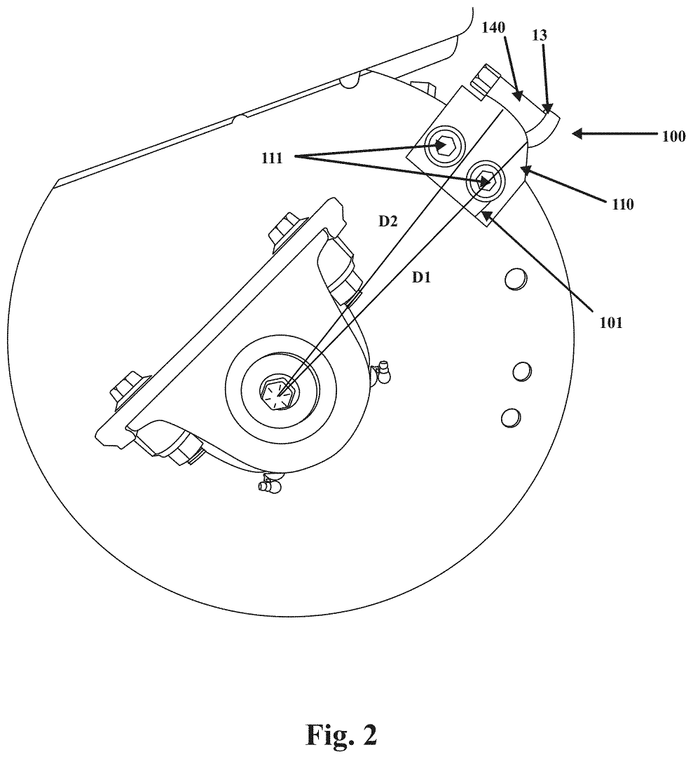

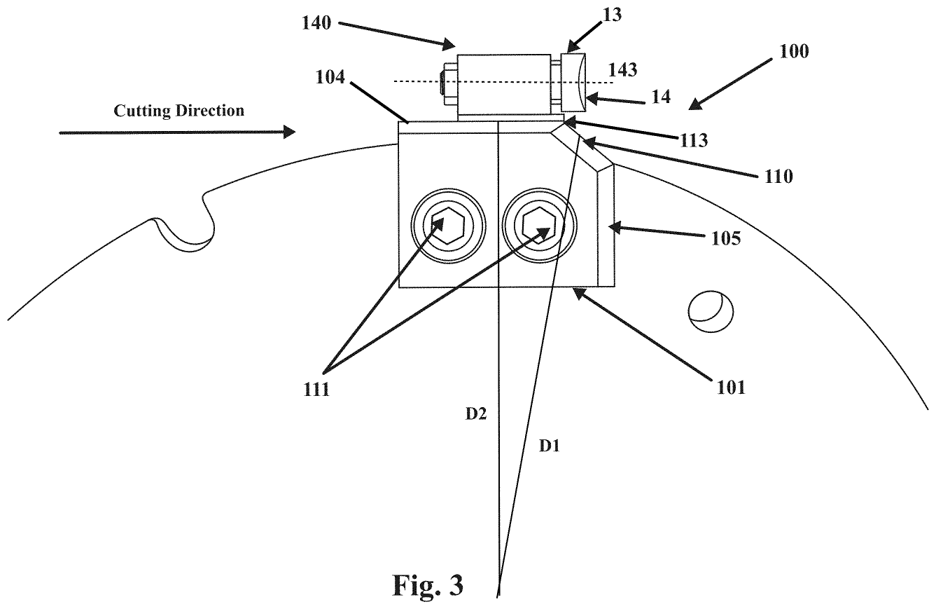

As shown in FIGS. 1 and 2, in one embodiment, a stump grinding assembly 10, includes a cutting wheel 11, cutting tooth mounting blocks 100, and cutting teeth 13 secured to each of the mounting blocks 100. In one embodiment, three cutting tooth mounting blocks 100, each fitted with a single cutting tooth 13, are mounted on the cutting wheel 11. According to one embodiment, the stump grinding assembly 10 and/or mounting blocks 100 may be used with a small stump grinder unit, under 40 horsepower. According to some embodiments, the stump grinding assembly 10 uses three mounting blocks 100 and three cutting teeth 13 which increases the available bite the cutting teeth take. Three equidistant teeth can be positioned at offset angles of 120 degrees each with respect to the center of the wheel, which can allow a single tooth at a time to be engaged with the stump. Therefore, an increased amount of power may be transferred to a single tooth. Increasing power on a single tooth can increase the cutting efficiency of the stump grinding machine. Moreover, decreasing the number of mounting blocks and cutting teeth can reduce the replacement costs and can reduce the time involved to remove and replace the cutting teeth and/or mounting blocks. A cutting tooth or cutting teeth are replaceable cutting tools that have a carbide tip on the cutting surface 14/front end and a fastener-like shape, with threads at the opposite end for securing, as shown in FIG. 3.

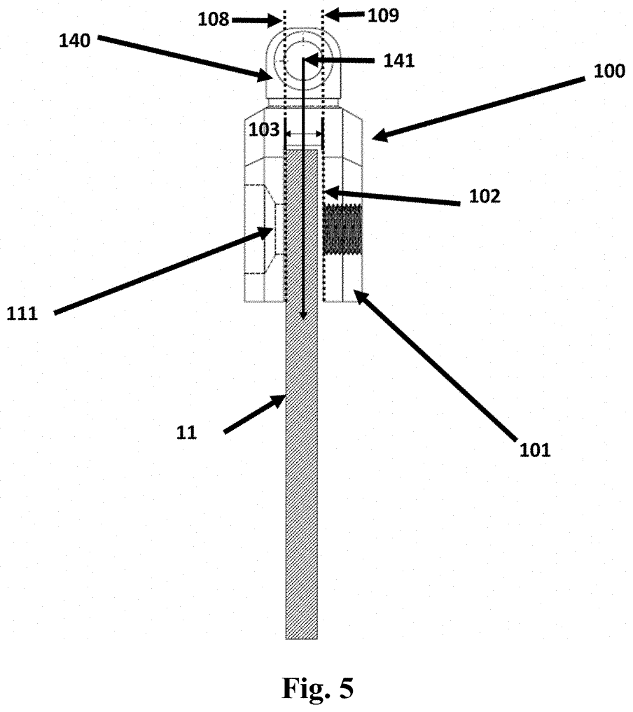

As illustrated in FIG. 2 and FIG. 3, in some embodiments, the cutting tool mounting block includes a body portion 101, and a cutting tool housing 140. The body portion 101, as shown FIG. 5, can define a channel 102 having a width 103. The width 103 of the channel 102 is dimensioned to mount over a periphery of the cutting wheel 11, according to some embodiments. The body portion 101 can also include a fastening feature 111 that is operable to maintain a fixed relationship between the cutting tool housing 140 and the periphery of the wheel. The fastening feature may be two socket head cap screws. Other embodiments include other fastening mechanisms such as stud bolts, fasteners, rivets, screws, nails, grommets, welding, and the like. The cutting tool housing 140 can include a through circumferential aperture where the aperture can be configured to accept the cutting tooth 13. In some embodiments, the aperture is dimensioned to ensure that the cutting tooth 13 fits snuggly. According to some embodiments, the body portion 101 also comprises a front feature 110. The front feature 110 may define a surface that extends diagonally from the outermost edge 104 of the body portion 101 towards the leading edge 105 of the body portion 101. The radial distance D1 between the center of the wheel and any point along the front feature 110 is less than a radial distance D2 between the center of wheel and the outermost edge 104 of the body portion 101, in some embodiments.

In some embodiments, as illustrated in FIG. 2, with continuous use, the front feature 110 of the body portion 101 wears but maintains a smaller radial distance D1 from the center of the wheel to any portion on the front feature in comparison with the radial distance D2 from the center of the wheel to the outermost edge 104 of the body portion 101. With continuous wear, the fasteners can remain protected from loads experienced during the operation of the stump grinder.

In one embodiment, the length of the cutting tooth 13 is substantially parallel to the cutting direction when the cutting tooth is coupled to the cutting tool housing 140. The alignment in this embodiment can increase the surface area of the cutting tooth cutting surface 14 with respect to the stump. The cutting direction is the tangential vectors at the periphery of the cutting wheel 11 formed by the rotation of the cutting wheel, in the direction of rotation.

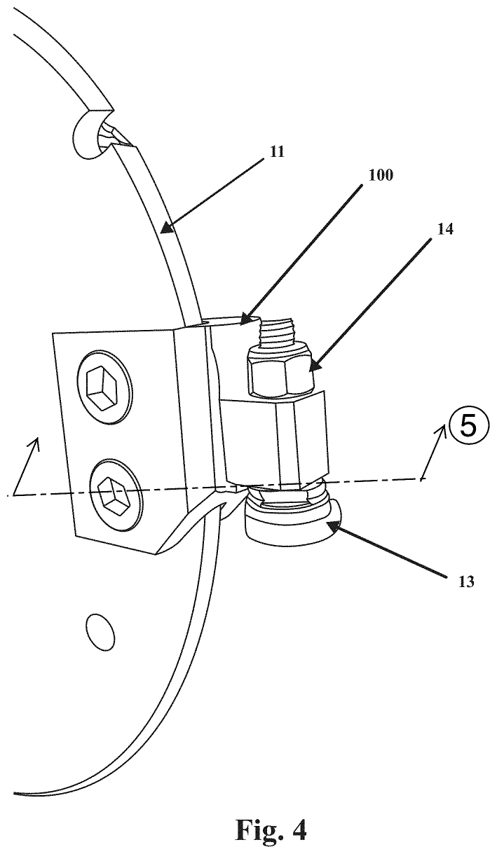

In some embodiments, as shown in FIG. 4, the front feature 110 partially sits below the periphery of the wheel, thus allowing a clearance between the cutting tooth cutting surface 14 and the wheel. This feature can minimize the surface area of the mounting block 100 in contact with the stump when the stump grinder is operating. Furthermore, the smooth transition from the front feature 110 can reduce the amount of kickback that the stump grinder experiences when it contacts the stump.

According to one embodiment, as shown in FIG. 4, the fasteners in the fastening feature 111 sit flush with respect to the outside surface of the body portion 101. This embodiment can reduce drag and provides protection to the fasteners during the operation of the stump grinder. The body portion 101 design, which may be configured to fit over the periphery of the wheel 11, can decrease the risk of shearing the fasteners since the load is transferred uniformly across the first and second sides of the body portion 101, according to some embodiments.

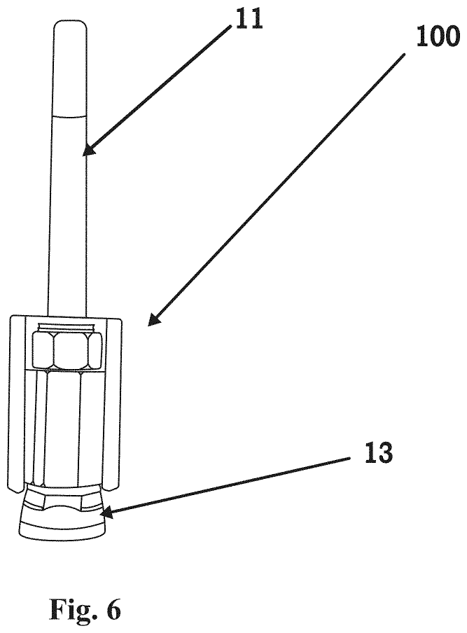

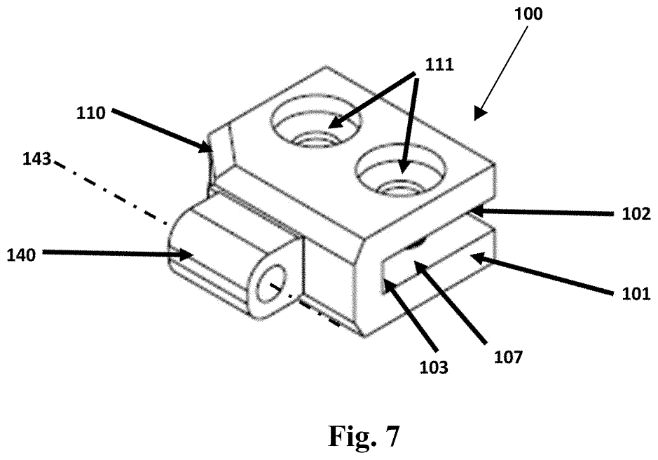

In some embodiments, as shown in FIG. 5 and FIG. 6, the cutting tool housing 140 defines an aperture 141 that is configured to couple with a cutting tooth 13. The aperture can include a cylindrical profile or other suitable shape and defines a central axis 143, as seen in FIG. 7. The central axis 143 may be substantially aligned with the channel 102. In the one embodiment, the central axis 143 of the aperture 141 is centered with respect to the width of the channel 103. The position of this embodiment can optimize the width of the mounting block, thereby decreasing chip recirculation, particularly when the grinder reaches, for example, 8-15 inches below ground. As presented in some embodiments, the width of the cutting tool mounting block 100 and position of the cutting tooth 13 reduces the paddlewheel effect whereby wood chips, dirt, mud, and the like, spin with the cutter and decrease the available cutting power. Having a single cutting tooth 13 can decrease the drag caused by a follower tooth due to the rebound effect in the elasticity of the wood.

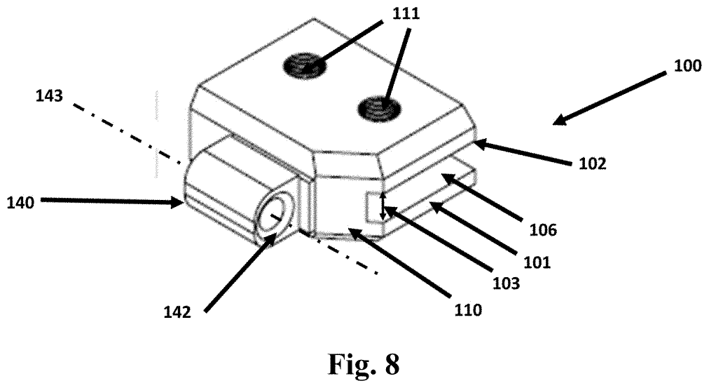

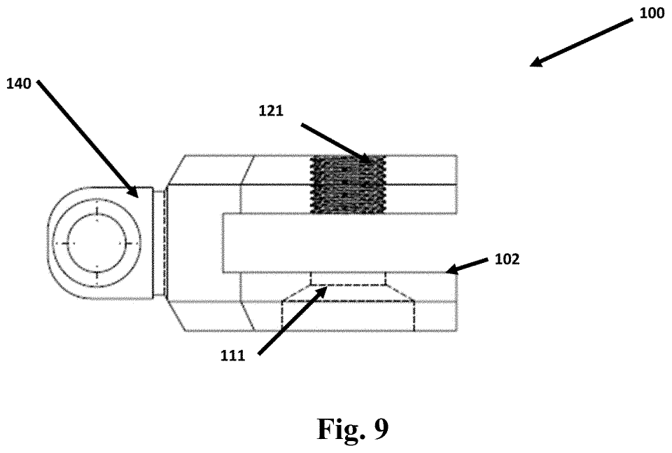

FIGS. 7 and 8 show an isometric view of an embodiment of the cutting tool mounting block 100. In some embodiments, the fastening feature 111 includes two through bores on a first side and a second side of the body portion 101. As shown in FIG. 7, in some embodiments, the first side 106 is counterbored. As shown in FIG. 8, in some embodiments, the second side 107 can be threaded. In one embodiment, the fasteners sit flush with respect to the first and second side. As shown in FIG. 9 the counterbore on the first side may also comprise an angled shoulder. Fasteners used can be wear-resistant with an angled shoulder to provide greater holding power. In some embodiments, as shown in FIG. 8, the cutting tool housing 140 may further comprise an angled shoulder 142 on the front side of the aperture to accommodate the shape of the cutting tooth. As illustrated in FIG. 7, the edges of the body portion 101 and of the cutting tool housing 140 may be chamfered.

A cutting tool mounting block 100 according to some embodiments of the present disclosure can be used for stump removal tool. Such a cutting tool mounting block 100 may include a body portion 101 defining a channel 102, the channel 102 having a width 103. According to some embodiments, the body portion 101 is operable to mount over the periphery of the cutting wheel 11. In some embodiments, the cutting tool mounting blocks 100 have a fastening feature 111 which is operable to couple the cutting wheel 11 to the cutting tool mounting block 100. Such a fastening feature 111 can fix or secure the cutting tool mounting block 100 to the cutting wheel 11. According to some embodiments, the cutting tool mounting block 100 includes an aperture 141 that has a central axis 143. Such aperture 141 can be configured to accept a cutting tooth 13. The central axis 143 of the aperture 141 is substantially aligned with respect to the channel 102, according to some embodiments.

According to some embodiments, the channel 102 includes a first sidewall 106 and a second sidewall 107. The central axis 143 of the aperture 141, in one embodiment, is situated between a radial projections 108 and 109 of the first sidewall 106 and second sidewall 107. The radial projections 108 and 109 refer to the projections of the sidewalls in the direction of the radius of the wheel, in a direction away from the cutting wheel 11, when the mounting block 100 is secured to the cutting wheel 11. In other embodiments, the central axis 143 may be outside either the radial protection of the first sidewall 108, the radial projection of the second sidewall 109, or both. In some embodiments, the first and second sidewalls are parallel. In other embodiments, the first and second sidewall are not parallel. The length of the cutting tooth 13, when mounted on the mounting block 100, can be substantially parallel to the cutting direction. The fastening feature 111 may include at least a bore on a first and a second side of the body, and the bore on the second side may be threaded. The bore or bores on the first side may be counterbored.

In some embodiments, the body portion 101 also includes a front feature 110. When mounted on the cutting wheel 11, the radial distance D1 between the center of the cutting wheel 11 and the front feature 110 is less than the radial distance D2 between the center of the cutting wheel 11 and the outermost edge 104 of the body portion 101, according to some embodiments. The cutting surface of the cutting tooth 13 can be in front of the outermost edge 104 of the body portion 101 in the direction of cutting when a cutting tooth 13 is mounted in the mounting block 100. The front feature 110 may form an angle of at least 10 degrees with respect to the cutting direction. According to some embodiments, the angle of the front feature 110 may not exceed 60 degrees. The outside surfaces of the mounting blocks can be at least partially chamfered. The mounting block is made of hardened steel, in some embodiments.

A cutting tool mounting block 100, according to some embodiments of the present disclosure, can be used for stump removal tool. Such a cutting tool mounting block may include a body portion 101 defining a channel 102. Such channel has a first sidewall 106 and a second sidewall 107. According to some embodiments, the body portion 101 is operable to mount over the periphery of the cutting wheel 11. The body portion 101 may also include a fastening feature 111 that is operable to couple the cutting wheel 11 to the body portion 101, according to some embodiments. The body portion 101 can include a front feature 110 where the radial distance D1 between the center of the wheel and the front feature 110 is less than the radial distance between the center of the cutting wheel and an outermost edge 104 of the body portion 101 when the mounting block is mounted on the cutting wheel 11. The mounting block 100 can also include a cutting tool housing 140 that defines an aperture 141. Such an aperture 141 has a central axis 143 that is configured to accept a cutting tooth 13. The central axis 143 is situated between a projection of the first sidewall and a projection of the second sidewall, in some embodiments. The cutting surface 14 of the cutting tooth 13 is in front of the outermost edge 104 of the body portion 101 in the direction of cutting when a cutting tooth 13 is mounted in the mounting block 100.

In some embodiments, the cutting tooth 13 is substantially parallel to the cutting direction when the cutting tooth 13 is coupled to the cutting tool housing 140. The front feature 110 may form an angle of at least 10 degrees with respect to the cutting direction, in some. This angle may be more than 60 degrees, according to other embodiments. The mounting block 100 includes, in some embodiments, a fastening feature 111. Such fastening feature 111 may include at least a bore on a first and a second side of the body; and the bore on the second side may be threaded. However, other embodiments, may include one, two, three, or any number of bores. In some embodiments, the bore or bores on the first side is or are counterbored.

A stump grinding configuration assembly 10, according to some embodiments, can be used for stump removal. The assembly can include a cutting wheel 11, three cutting tool mounting blocks 100, and three cutting teeth 13. Each of the cutting tool mounting blocks 100 include, according to some embodiments, a body portion 101 that defines a channel 102. Such channel 102 can have a width 103, which is operable to mount over a periphery of the cutting wheel 11. The body portion 101 may include a fastening feature 111 that is operable to couple the mounting block to the cutting wheel 11. Such fastening feature 111 may be operable to fix the mounting block 100 with respect to a periphery of the cutting wheel 11. In some embodiments, the body portion also includes a front feature 110. In the front feature 110, the radial distance D1 between a center of the cutting wheel 11 and the front feature 110 can be less than a radial distance D2 between the center of the wheel and an outermost edge 104 of the body portion 101. In some embodiments, the mounting block 100 includes an aperture 141. This aperture 141 can have a central axis 143 that is configured to accept a cutting tooth 13. The central axis 143 of the aperture 141 can be substantially aligned with the channel. In some embodiments, the cutting surface 14 of the cutting tooth 13 is between the front boundary 113 of the outermost edge 104 of the body portion 101 and the leading edge 105 when a cutting tooth 13 is mounted in the cutting tool mounting block 100. The channel 102 can include a first sidewall 106 and a second sidewall 107. The central axis 143 in the aperture 141 can be situated between a radial projection of the first sidewall and a radial projection of the second sidewall. In one embodiment, each of the three mounting blocks mounted on the wheel are equidistantly spaced. In some embodiments, the stump grinder unit has less than 40 horsepower. The assembly may include one, two, or numerous mounting block and cutting tooth assemblies.

According to some embodiments, the mounting block 100 is a generally rectangular shape. In one embodiment, the channel 102 is the portion that overlaps with the cutting wheel 11 when the cutting tool mounting block 100 is mounted on the cutting wheel 11. Such channel 102 can extend through the length of the mounting block 100. According to some embodiments, the body portion 101 defines a U-shape. The cutting tool housing 140 is generally cylindrical with a square base, in one embodiment. In some embodiments, the body portion 101 also includes a back feature, symmetrical to the front feature 110. The cutting tool housing 140 can be removably coupled to the body portion 101. In other embodiments, the body portion may consist of multiple pieces, removably coupled to one another by any fastening means including, but not limited to, fasteners, welding, rivets, grommets, welding, among others. The body portion may be circular, oval, hexagonal, or other geometrical shapes. In other embodiments, the cutting tool housing may include multiple cutting teeth. The mounting block 100 and fastening feature 111 can be dimensioned to match off-the-shelf stump grinding wheels. In some embodiments, the thickness of the body portion 101 is dimensioned to be proportional to the operating life of the mounting block. According to some embodiments, the cutting tool housing 140 partially contains carbide on its outside surface. The mounting blocks and the wheel can be a singular piece.

The cutting tooth mounting block may be made from tool steel, hardened steel, treated steel, iron alloys, heavy metal alloys, aluminum alloys, and/or other materials or a combination of two or more materials. The material can be wear resistant to prolong the life of the mounting block. Other embodiments include corrosion resistant materials. The mounting block can be made by machining a single piece of material. In some embodiments, the mounting block may be coated with epoxy, thermal sprayed aluminum, and/or other materials or a combination of two or more materials.

What is claimed is:

1. A cutting tool mounting block for a stump removal tool, the cutting tool mounting block comprising:
a body portion defining a channel, the body portion operable to mount over a periphery of a wheel;
a fastening feature operable to couple the body portion to the wheel, the fastening feature operable to fix the mounting block with respect to the periphery of the wheel; and
an aperture, the aperture having a central axis, the aperture is configured to accept a cutting tooth extending along the central axis, wherein the central axis is substantially aligned with the channel.

2. The cutting tool mounting block of claim 1, the channel further comprising:
a first sidewall and a second sidewall, wherein the central axis of the aperture is situated between a radial projection of the first sidewall and a radial projection of the second sidewall.

3. The cutting tool mounting block of claim 1 wherein a length of the cutting tooth is substantially parallel to a cutting direction when the cutting tooth is coupled to the aperture.

4. The cutting tool mounting block of claim 1, fastening feature further comprising:
two bores on a first side and two bores on a second side of the body portion, wherein the bores on the first side are counterbored and the bores on the second side are threaded.

5. The cutting tool mounting block of claim 1 further comprising:
a front feature wherein,
a radial distance between a center of the wheel and the front feature is less than a radial distance between the center of the wheel and an outermost edge of the body portion; and
a cutting surface of the cutting tooth is in front of the outermost edge of the body portion in a cutting direction when the cutting tooth is mounted in the aperture.

6. The cutting tool mounting block of claim 5 wherein the front feature forms an angle of at least 10 degrees with respect to the cutting direction and the angle is no more than 60 degrees.

7. The cutting tool mounting block of claim 1 wherein an outside surface of the body portion is at least partially chamfered.

8. A cutting tool mounting block for a stump removal tool, the cutting tool mounting block comprising:
a body portion defining a channel, the channel having a first sidewall and a second sidewall, the body portion is operable to mount over a periphery of a wheel;
a fastening feature operable to couple the wheel to the mounting block;
a front feature wherein,
a radial distance between a center of the wheel and the front feature is less than a radial distance between the center of the wheel and an outermost edge of the body portion;
a cutting tool housing defining an aperture, the aperture having a central axis that is configured to accept a cutting tooth, wherein the central axis is situated between a project of the first sidewall and a projection of the second sidewall; and
a cutting surface of the cutting tooth is in front of the outermost edge of the body portion in a cutting direction when a cutting tooth is mounted in the mounting block.

9. The cutting tool mounting block of claim 8 wherein the cutting tooth is substantially parallel to the cutting direction when the cutting tooth is coupled to the cutting tool housing.

10. The cutting tool mounting block of claim 8 wherein the front feature forms an angle of at least 10 degrees with respect to the cutting direction and the angle is no more than 60 degrees.

11. The cutting tool mounting block of claim 8, the fastening feature further comprising:
two bores on a first side and two bores on a second side of the body portion, wherein the two bores on the first side are counterbored and the two bores on the second side are threaded.

12. The cutting tool mounting block of claim 8 wherein an outside surface of the body portion and an outside surface of the cutting tool housing are at least partially chamfered.

13. A stump grinding configuration assembly for stump removal comprising:
a wheel;
three cutting tool mounting blocks comprising:
a body portion defining a channel, the channel having a width and that is operable to mount over a periphery of the wheel;
a fastening feature operable to couple the body portion to the wheel, the fastening feature operable to fix the mounting block with respect to the periphery of the wheel;
a front feature wherein,
a radial distance between a center of the wheel and the front feature is less than a radial distance between the center of the wheel and an outermost edge of the body portion;
an aperture, the aperture having a central axis that is configured to accept a cutting tooth, wherein the central axis is substantially aligned with the channel; and
a cutting surface of the cutting tooth is in front of the outermost edge of the body portion in a cutting direction when the cutting tooth is mounted in the aperture.

14. The stump grinding configuration assembly of claim 13, the channel further comprising:
a first sidewall and a second sidewall, wherein the central axis of the aperture is situated between a radial projection of the first sidewall and a radial projection of the second sidewall.

15. The stump grinding configuration assembly of claim 13 wherein the cutting tool mounting blocks are equidistantly spaced.

16. The stump grinding configuration assembly of claim 13 further comprising a stump grinder unit of less than 40 horsepower.

17. The stump grinding configuration assembly of claim 13 wherein the cutting tooth is substantially parallel to a cutting direction when the cutting tooth is coupled to the cutting tool housing.

18. The stump grinding configuration assembly of claim 13 wherein the front feature forms an angle of at least 10 degrees with respect to the cutting direction and the angle is no more than 60 degrees.

19. The stump grinding configuration assembly of claim 13, the fastening feature further comprising:
two bores on a first side and two bores on a second side of the body portion; wherein the two bores on the first side are counterbored and the two bores on the second side are threaded.

20. The stump grinding configuration assembly of claim 13 wherein an outside surface of the cutting tool mounting blocks are at least partially chamfered.
